(19) United States
(12) Patent Application Publication
(10) Pub. No.: US 2019/0311136 A1
(43) Pub. Date: Oct. 10, 2019

(54) SYSTEMS AND METHODS FOR UTILIZING AN INFORMATION TRAIL TO ENFORCE DATA LOSS PREVENTION POLICIES ON POTENTIALLY MALICIOUS FILE ACTIVITY

(71) Applicant: Symantec Corporation, Mountain View, CA (US)

(72) Inventors: Manish Pai, Pune (IN); Prahalad Deshpande, Pune (IN); Sumesh Jaiswal, Pune (IN)

(21) Appl. No.: 15/984,869

(22) Filed: May 21, 2018

(30) Foreign Application Priority Data
Apr. 5, 2018 (IN) 201811013062

(51) Int. Cl. G06F 21/60; G06F 21/55; H04L 29/06

(52) U.S. Cl. CPC G06F 21/60; G06F 2221/034; H04L 63/20; G06F 21/554

(57) ABSTRACT

The disclosed computer-implemented method for utilizing an information trail to enforce data loss prevention policies on potentially malicious file activity may include (1) recording, by a computing device, one or more current activities associated with a file retrieved from a server, (2) linking, by the computing device, the current activities to one or more previously recorded activities associated with the file, (3) generating, by the computing device, a graph including nodes representing an information trail of related events associated with the current activities and the previously recorded activities, (4) determining, by the computing device, a severity of the information trail based on one or more rules, and (5) performing, by the computing device, a data loss prevention action on one or more operations associated with the file based on potential malicious activity. Various other methods, systems, and computer-readable media are also disclosed.

### BACKGROUND

Enterprise computer networks often utilize data loss prevention (DLP) software that contains policies for protecting sensitive data from malicious users and/or preventing sensitive data leaks. Traditional DLP solutions may include content policies for monitoring outbound network files, identifying file types, extracting file content, running a DLP policy based on the content, and taking any necessary corrective action (such as blocking the downloading of the network file) based on the policy.

Unfortunately, traditional DLP solutions often suffer from a number of drawbacks that may prevent them from detecting sensitive outbound operations and/or the exfiltration (e.g., data theft) of sensitive content. For example, traditional DLP solutions may fail to detect sensitive file types that a malicious user may modify to another file type prior to downloading to a removable storage device. Thus, a malicious user may use a hex editor to change a file type for sensitive files (e.g., a word processor file type) to a non-sensitive file type (e.g., an image file type) to avoid detection. Traditional DLP solutions may also fail to detect malicious software introduced to an enterprise network from an outside source (e.g., a USB drive) that may utilize a custom protocol to scan and transfer sensitive network files to an anonymous server.

### SUMMARY

As will be described in greater detail below, the instant disclosure describes various systems and methods for utilizing an information trail to enforce data loss prevention policies on potentially malicious file activity.

In one example, a computer-implemented method for utilizing lifecycle analytics to enforce data loss prevention policies on potentially malicious content may include (1) recording, by a computing device, one or more current activities associated with a file retrieved from a server, (2) linking, by the computing device, the current activities to one or more previously recorded activities associated with the file, (3) generating, by the computing device, a graph including nodes representing an information trail of related events associated with the current activities and the previously recorded activities, (4) determining, by the computing device, a severity of the information trail based on one or more rules, the severity associated with a likelihood of potential malicious activity, and (5) performing, by the computing device, a data loss prevention action on one or more operations associated with the file based on the potential malicious activity.

In some examples, the recording of current activities associated with a file retrieved from a server may include recording (1) a file creation operation, (2) a file copy operation, (3) a file delete operation, (4) a file read operation, (5) a file rename operation, (6) a file write operation, (7) file download operation, and/or (8) a file upload operation. In some examples, determining the severity of the information trail based on one or more rules may include: (1) identifying a file operation associated with each node in the information trail, (2) applying the one or more rules to the file operation, and (3) assigning a risk indicator to each node based on the one or more rules. In one example, the risk indicator may correspond to a likelihood of the potential malicious activity.

In some examples, the rules may include: (1) a content sensitivity associated with the file, (2) a mismatched file extension associated with the file, (3) a reputation of a process for accessing the file, (4) a blacklisted internet protocol address associated with the file, (5) a file encryption associated with the file, (6) exfiltration activity associated with the file, and/or (7) an endpoint location associated with the file.

In one example, the data loss prevention action may include includes blocking the operations associated with the file. Additionally, or alternatively, the data loss prevention action may include collecting data generated by the operations associated with the file for analysis. Additionally, or alternatively, the data loss prevention action may include collecting data generated by the operations for updating a data loss prevention model.

In one embodiment, a system for implementing the above-described method may include (1) a recording module, stored in memory, that records, by a computing device, one or more current activities associated with a file retrieved from a server, (2) a linking module, stored in memory, that links, by the computing device, the current activities to one or more previously recorded activities associated with the file, (3) a generation module, stored in memory, that generates, by the computing device, a graph including nodes representing an information trail of related events associated with the current activities and the previously recorded activities, (4) a determination module, stored in memory, that determines, by the computing device, a severity of the information trail based on one or more rules, the severity associated with a likelihood of potential malicious activity, (5) a security module, stored in memory, that performs, by the computing device, a data loss prevention action on one or more operations associated with the file based on the potential malicious activity, and (6) at least one physical processor configured to execute the recording module, the linking module, the generation module, the determination module, and the security module.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) record one or more current activities associated with a file retrieved from a server, (2) link the current activities to one or more previously recorded activities associated with the file, (3) generate a graph including nodes representing an information trail of related events associated with the current activities and the previously recorded activities, (4) determine a severity of the information trail based on one or more rules, the severity associated with a likelihood of potential malicious activity, and (5) perform a data loss prevention action on one or more operations associated with the file based on the potential malicious activity.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for utilizing an information trail to enforce data loss prevention policies on potentially malicious file activity.

FIG. 2 is a block diagram of an additional example system for utilizing an information trail to enforce data loss prevention policies on potentially malicious file activity.

FIG. 3 is a flow diagram of an example method for utilizing an information trail to enforce data loss prevention policies on potentially malicious file activity.

FIG. 4 is a block diagram of an information trail generated by an example system for utilizing an information trail to enforce data loss prevention policies on potentially malicious file activity.

FIG. 5 is a data flow of an additional example method for utilizing an information trail to enforce data loss prevention policies on potentially malicious file activity

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for utilizing an information trail to enforce data loss prevention policies on potentially malicious file activity. As will be explained in greater detail below, by recording and correlating related activities and events such as file launching, file reading, and file creation activities on an endpoint device in a computing network, the systems and methods described herein may be able to create a visual information trail that identifies potentially risky file operations associated with malicious activity. By utilizing the information trail in this way, the systems and methods described herein may be able to improve the identification of malicious activity for applying data loss prevention (DLP) policies, thereby reducing leaks of sensitive content from a computer network when compared to traditional DLP software agents that only analyze individual file operations without correlating related events.

Moreover, the systems and methods described herein may improve the functioning and/or performance of an endpoint computing device in a computing network by detecting potentially malicious files with increased accuracy and thus reducing the likelihood of infection. These systems and methods may also improve the field of enterprise-level computer network security by detecting potentially malicious activities performed by file operations on endpoint devices, thereby protecting the computing network from malicious attacks.

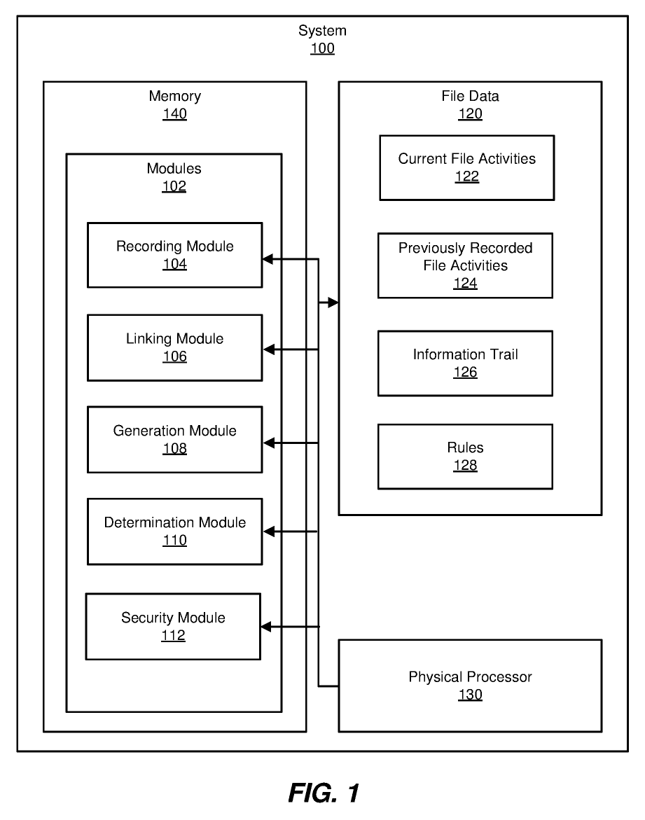

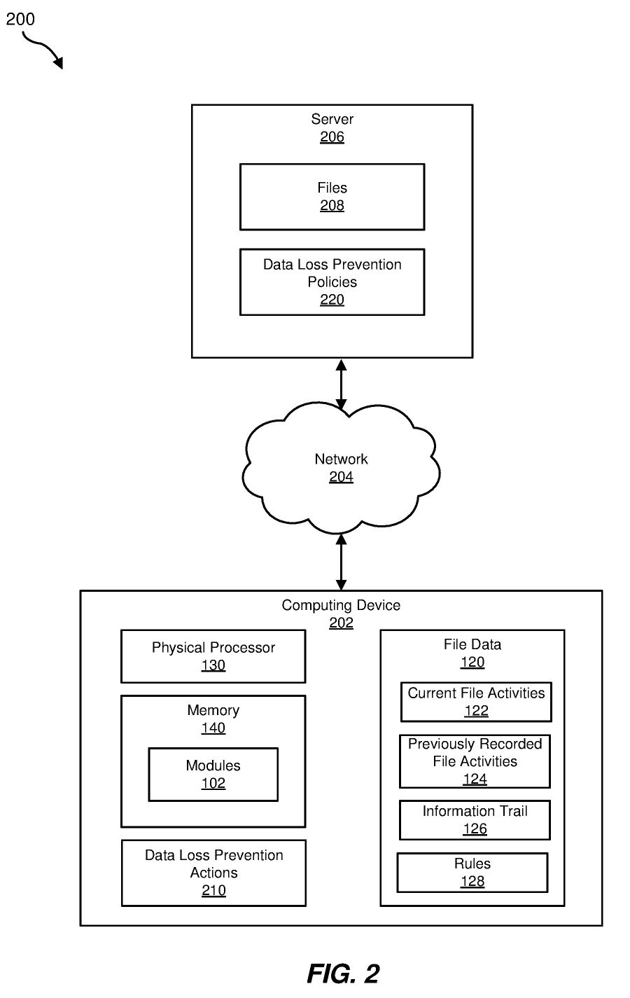

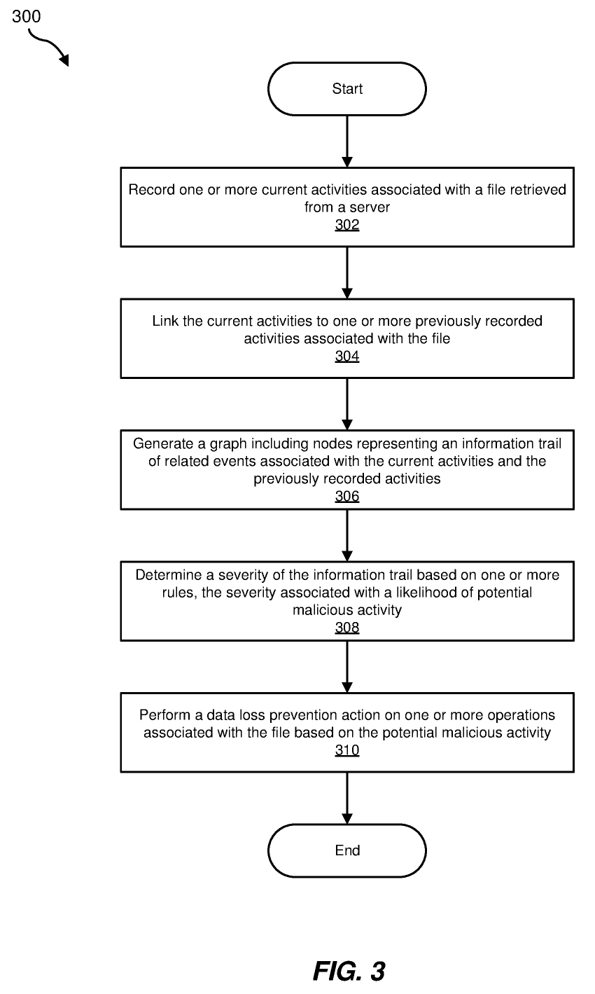

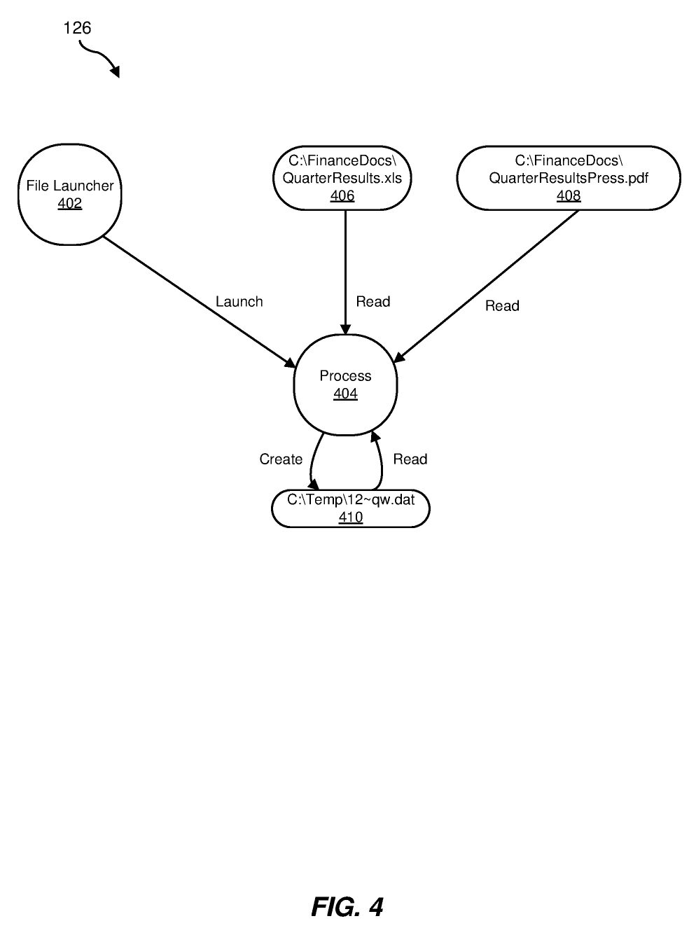

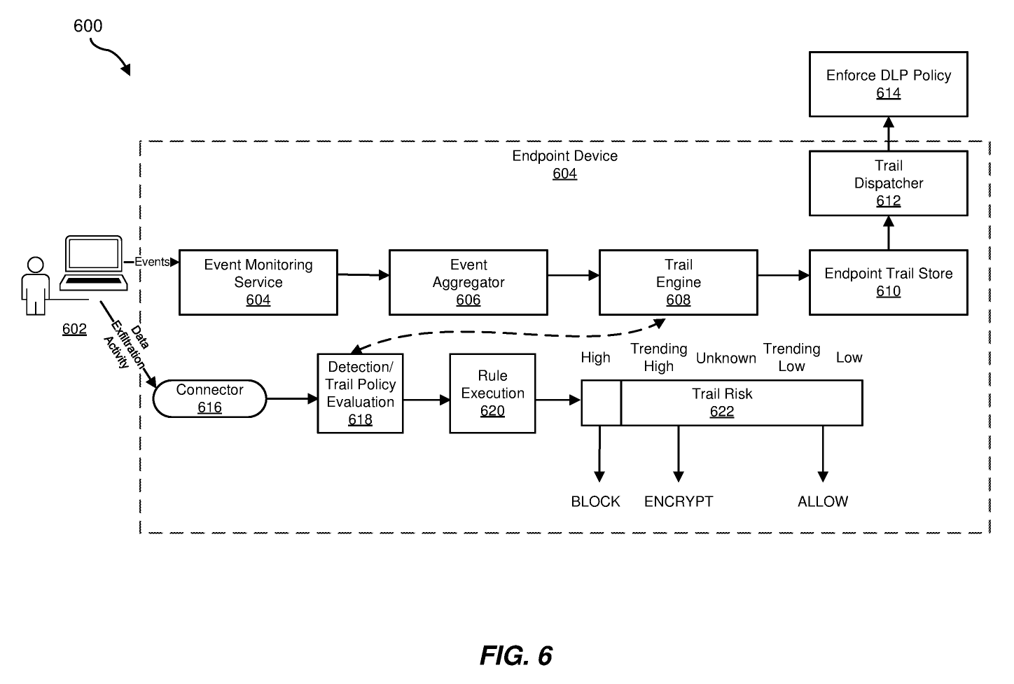

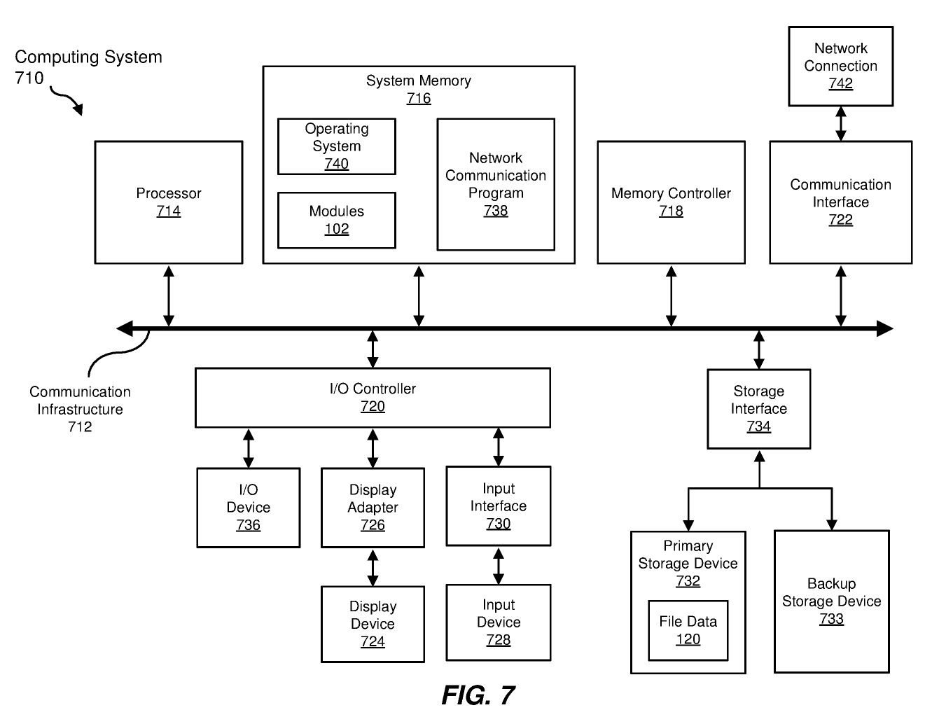

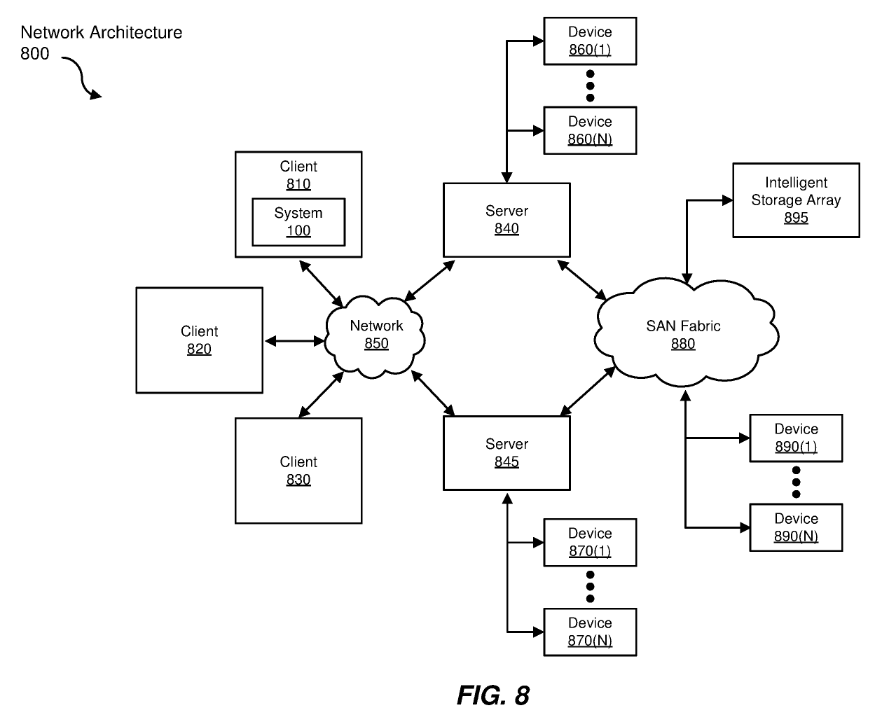

The following will provide, with reference to FIGS. 1-2, detailed descriptions of example systems for utilizing an information trail to enforce data loss prevention policies on potentially malicious file activity. Detailed descriptions of corresponding computer-implemented methods will also be provided in connection with FIGS. 3-4. A detailed description of an information trail generated by an example system for utilizing lifecycle analytics to enforce data loss prevention policies on potentially malicious file activity. In addition, detailed descriptions of an example computing system and network architecture capable of implementing one or more of the embodiments described herein will be provided in connection with FIGS. 6 and 7, respectively.

FIG. 1 is a block diagram of an example system 100 for utilizing an information trail to enforce data loss prevention policies on potentially malicious file activity. As illustrated in this figure, example system 100 may include one or more modules 102 for performing one or more tasks. For example, and as will be explained in greater detail below, example system 100 may include a recording module 104 that records current activities associated with a file retrieved from a server. Example system 100 may additionally include a linking module 106 that links the current activities to previously recorded activities associated with the file. Example system 100 may also include a generation module 108 that generates a graph that includes nodes representing an information trail of related events associated with the current activities and the previously recorded activities. Example system 100 may additionally include a determination module 110 that determines a severity of the information trail based on one or more rules. The severity may be associated with a likelihood of potential malicious activity. Example system 100 may also include a security module 112 that performs a data loss prevention action on one or more operations associated with the file based on the potential malicious activity. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate utilizing an information trail to enforce data loss prevention policies on potentially malicious file activity. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include file data 120. File data 120 may include current file activities 122, previously recorded file activities 124, information trail 126, and rules 128. Examples of current file activities 122 and previously recorded file activities 124 may include, without limitation, file creation operations, file copy operations, file delete operations, file read operations, file rename operations, file write operations, file download operations, and file upload operations. Examples of rules 128 may include, without limitation, a content sensitivity associated with a file, a mismatched file extension associated with a file, a reputation of a process for accessing a file, a blacklisted internet protocol (IP) address associated with a file, a file encryption associated with a file, exfiltration activity associated with a file, or an endpoint location associated with a file.

The term “information trail,” as used herein, generally refers to a graph of previous and current file activities that may be visually represented as a series of related events. In some examples, the graph may be composed of multiple nodes where each node represents a file. In some examples, the graph may include a node representing a primary file (e.g., an executable file) that may perform various operations (e.g., read, create, or launch operations) on other nodes representing additional files. In some examples, the graph may be utilized for determining potentially malicious activity associated with a primary file node based on the various operations performed with respect to the other file nodes.

The term “severity,” as used herein, generally refers to a likelihood of various file operations corresponding to malicious activity. In some examples, severity may be determined based on a series of rules defining potentially malicious file activities or attributes such as content sensitivity, a file type not matching a file extension, reputation of a process for accessing a file, a blacklisted IP address as a file exfiltration destination, encrypted (e.g., uncrackable) files, an exfiltration mode or device associated with a file, and/or an endpoint location associated with a file.

The term “malicious activity,” as used herein, generally refers to any unauthorized activity associated with one or more files in violation of a data loss prevention policy. In some examples, malicious activity may include data theft (e.g., the exfiltration of files and/or data from a server or endpoint device), file modification, and/or the introduction of malicious files into a computing network.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202 and/or any other suitable computing system. As will be described in greater detail below, one or more of modules 102 from FIG. 1 may, when executed by at least one processor of computing device 202, enable computing device 202 to utilize an information trail to enforce data loss prevention policies on potentially malicious file activity. For example, and as will be described in greater detail below, one or more of modules 102 may cause computing device 202 and/or server 206 to (1) record current file activities 122 associated with accessing a file 208 from server 206, (2) link current file activities 122 to previously recorded file activities 124, (3) generate a graph including nodes representing information trail 126 of related events associated with current file activities 122 and previously recorded file activities 124, (4) determine a severity of information trail 126 based on rules 128 to identify potential malicious activity, and (5) perform a data loss prevention action 210 on one or more operations associated with a file 208 based on the potential malicious activity.

Computing device 202 generally represents any type or form of computing device capable of reading computer-executable instructions. In one example, computing device 202 may represent an endpoint computing device running client-side DLP agent software in an enterprise computing network. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of hosting files 208 and data loss prevention policies 220. In one example, server 206 may be a DLP server for storing files 208, in accordance with data loss prevention policies 220, in an enterprise computing network. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for utilizing an information trail to enforce data loss prevention policies on potentially malicious file activity. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may record one or more current activities associated with a file retrieved from a server. For example, recording module 104 may, as part of computing device 202 in FIG. 2, record one or more current file activities 122 associated with a file 208 retrieved from server 206.

Recording module 104 may record current file activities 122 in a variety of ways. In one example, recording module 104 may be a component of a client-side DLP agent that monitors operations associated with files 208 retrieved from server 206 in accordance with data loss prevention policies 220. In some examples, monitored file operations may include, without limitation, file creation operations, file copy operations, file delete operations, file read operations, file rename operations, file write operations, file download operations, and/or file upload operations.

At step 304 in FIG. 3, one or more of the systems described herein may link the current activities recorded at step 302 with previously recorded activities associated with the file. For example, linking module 106 may, as part of computing device 202, link current file activities 122 with previously recorded file activities 124 that are associated with a file 208.

Linking module 106 may link current file activities 122 with previously recorded file activities 124 in a variety of ways. In one example, linking module 106 may be a component of a client-side DLP agent that associates previous operations performed by a file 208 with current operations. For example, linking module 106 may associate a previously recorded file read operation of a spreadsheet file with a current file creation operation associated with a generic data file.

At step 306 in FIG. 3, one or more of the systems described herein may generate a graph including nodes representing an information trail of related events associated with the current activities and the previously recorded activities linked at step 304. For example, generation module 108 may, as part of computing device 202, generate information trail 126 of related events associated with linked current file activities 122 and previously recorded file activities 124.

Generation module 108 may generate information trail 126 in a variety of ways. In one example, generation module 108 may be a component of a client-side DLP agent that generates information trail 126 as a graph of file nodes showing related events associated with linked current file activities 122 and previously recorded file activities 124. An example information trail 126 is shown in FIG. 4.

As shown in FIG. 4, information trail 126 may include file nodes 402, 404, 406, 408, and 410 associated with file launching, file reading, and file creation operations. For example, file node 404 (which may represent a file 208, may be launched from a launcher application represented by file node 402 and further read spreadsheet and portable document format (PDF) files having similar names but different file extensions, represented by file nodes 406 and 408. File node 404 may also create and then read a data generic data file which may be represented by file node 410.

As will be discussed in greater detail below, the related events represented by the file operations associated with file node 404 may be analyzed to determine potential malicious activity. For example, the change of a spreadsheet file extension associated with the file node 406 to a PDF file extension associated with file node 408 may indicate an attempt by a malicious user to obfuscate the theft of sensitive spreadsheet content disclosing a company's quarterly results as a press article in order to avoid detection by a company's DLP software.

Returning now to FIG. 3, at step 308, one or more of the systems described herein may determine a severity of the information trail generated at step 306 based on one or more rules. The severity may be associated with a likelihood of potential malicious activity. For example, determination module 110 may, as part of computing device 202, determine a severity of information trail 126 based on rules 128 to identify likely potential malicious activity associated with a file 208.

Determination module 110 may determine the severity of information trail 126 based on rules 126 in a variety of ways. In one example, determination module 110 may be a component of a client-side DLP agent that determines the severity of information trail 126 by identifying a file operation associated with each node in information trail 126, apply rules 128 to the file operation, and assign a risk indicator to each node based on applied rules 128. In some examples, the risk indicator may correspond to a likelihood of potential malicious activity associated with a file 208. In some examples, rules 128 may include a content sensitivity, a mismatched file extension, a reputation of a process for accessing a file 208, a blacklisted IP address associated with a file 208, a file encryption, exfiltration activity, and/or an endpoint location associated with a file 208. As an example, and as discussed above with respect to FIG. 4, determination module 110 may determine a severity for a file 208 as high risk (and thus corresponding to a high likelihood of malicious activity) when a file 208 is involved in operations including changing a file extension of a file containing sensitive content. As another example, determination module may also determine a severity for a file 208 as high risk (and thus corresponding to a high likelihood of malicious activity) when a file 208 is associated with a blacklisted IP address utilized by a malicious server.

At step 310 in FIG. 3, one or more of the systems described herein may perform a data loss prevention action on one or more operations associated with the file based on the potential malicious activity determined at step 308. For example, security module 112 may, as part of computing device 202, perform a data loss prevention action 210 on one or more operation associated with a file 208.

Security module 112 may perform a data loss prevention action 210 in a variety of ways. In one example security module 112 may be a component of a client-side DLP agent that may block on one or more outbound operations associated with a file 208. For example, security module 112 may block a current read or write operation involving a file 208 with a changed file extension, prevent a save operation for a file 208 to a removable media (e.g., a USB drive) that has previously been accessed by a process having a low reputation, and/or prevent a file 208 from being communicated over network 204 to a blacklisted IP address. Additionally, or alternatively, security module 112 may collect data generated by the one or more operations associated with a file 208 for analysis. For example, security module 112 may capture telemetry data associated with one or more potentially malicious information trails 126 and extract a malicious activity “signature.” For example, a malicious activity signature may include one or more operations associated with changing the file extension of a file 208 containing sensitive content or determining that a file 208 has been associated with a blacklisted IP address utilized by a malicious server. The extracted signature could then be distributed to other DLP agents for proactively detecting malicious activity. In some examples, multiple information trails 126 may be compared to detect common exfiltration patterns and understand user behavior. Additionally, or alternatively, security module 112 may collect data generated by the one or more file operations for updating a data loss prevention model. For example, security module 112 may capture telemetry data associated with one or more potentially malicious information trails 126 to supplement a data loss prevention model used to conduct a post mortem analysis following a data breach.

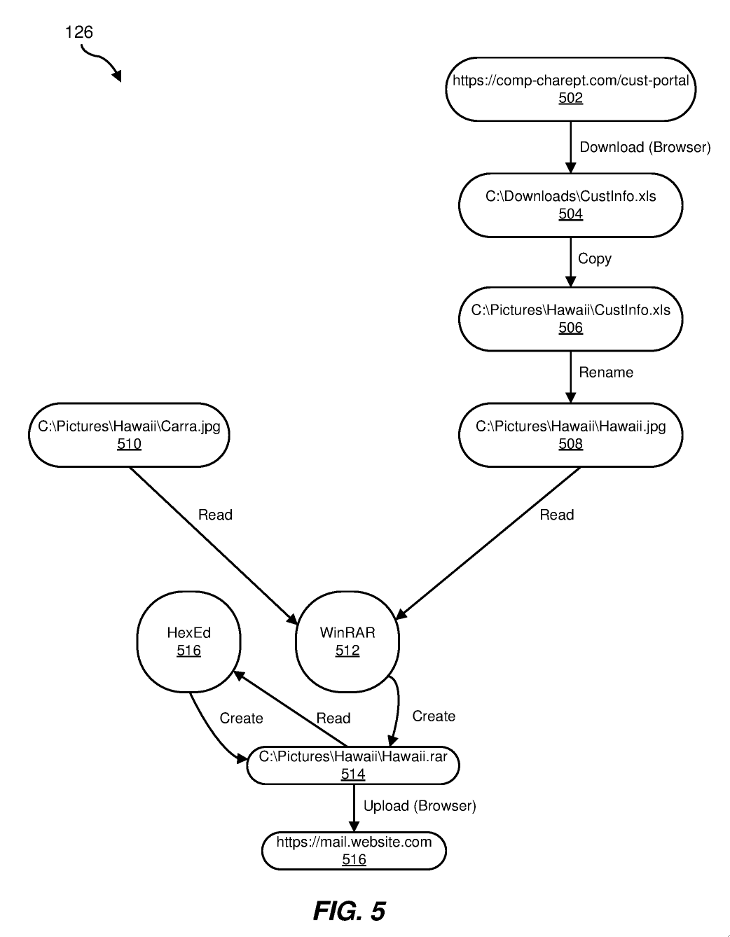

FIG. 5 is a data flow diagram 500 of an additional example method for utilizing an information trail to enforce data loss prevention policies on potentially malicious file activity. In some examples, various portions of data flow diagram 500 may be performed by modules similar to modules 102 of FIG. 1 or 2 (discussed above) on an endpoint device 504.

In the data flow diagram 500, a user 502 may generate one or more events that are received by an event monitoring service 504. An event aggregator 506 may aggregate the events from the event monitoring service 502 and send the events to a trail engine 506. Trail engine 506 may generate an information trail (such as information trail 126 of FIG. 1 or 2) that may be stored by endpoint trail store 510. A trail dispatcher 512 may receive the information trail from endpoint trail store 510 for enforcing a DLP policy 514.

In the data flow diagram 502, user 502 may also generate data exfiltration activity that may be received by connector 516 and sent to a detection/trail policy evaluation module 518. Detection/trail policy evaluation module 518 may also receive trail information from trail engine 508. Rule execution module 520 may execute rules (such as rules 128 of FIG. 1 or 2) on the trail information and/or the data exfiltration activity received by detection/trial policy evaluation module 518 and generate a trail risk indicator 522. In some examples, trail risk 522 may indicate whether the events and/or the data exfiltration activity received from user 502 represent a high, trending high, unknown, trending low, or low risk of malicious activity being performed on one or more file operations by user 502 and indicate a corresponding data loss prevention action. For example, a high risk of malicious activity may result in the received events and/or the data exfiltration activity being blocked by a DLP agent running on endpoint device 504, a trending high or unknown risk may result in the received events and/or the data exfiltration activity being encrypted, and a trending low or low risk may result in the received events and/or data exfiltration activity being allowed.

As explained above in connection with FIGS. 1-5, a client-side DLP agent on an endpoint device may be generate an information trail to enforce data loss prevention policies on potentially malicious file activity. By recording and correlating related activities and events such as file launching, file reading, and file creation activities on an endpoint device in a computing network, the systems and methods described herein may be able to create a visual information trail that identifies potentially risky file operations associated with malicious activity. By utilizing the information trail in this way, the systems and methods described herein may be able to improve the identification of malicious activity for applying data loss prevention (DLP) policies, proactively detect the malicious activity, detect common exfiltration patterns and understand user behavior, and generate evidence for post mortem analysis following a data breach. As a result, leaks of sensitive content from a computer network may be substantially reduced when compared to traditional DLP software agents that only analyze individual file operations without correlating related events.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, file data from FIG. 1 may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the instant disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for utilizing an information trail to enforce data loss prevention policies on potentially malicious file activity.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for utilizing an information trail to enforce data loss prevention policies on potentially malicious file activity, at least a portion of the method being performed by a computing device comprising at least one processor, the method comprising:
recording, by the computing device, one or more current activities associated with a file retrieved from a server;
linking, by the computing device, the current activities to one or more previously recorded activities associated with the file;
generating, by the computing device, a graph comprising nodes representing an information trail of related events associated with the current activities and the previously recorded activities;
determining, by the computing device, a severity of the information trail based on one or more rules, wherein the severity is associated with a likelihood of potential malicious activity; and
performing, by the computing device, a data loss prevention action on one or more operations associated with the file based on the potential malicious activity.

2. The method of claim 1, wherein recording, by the computing device, one or more current activities associated with the file retrieved from the server comprises recording at least one of:
a file creation operation;
a file copy operation;
a file delete operation;
a file read operation;
a file rename operation,
a file write operation;
a file download operation; and
a file upload operation.

3. The method of claim 1, wherein determining, by the computing device, the severity of the information trail based on one or more rules comprises:
identifying a file operation associated with each node in the information trail;
applying the one or more rules to the file operation; and
assigning a risk indicator to each node based on the one or more rules.

4. The method of claim 3, wherein the risk indicator corresponds to the likelihood of the potential malicious activity.

5. The method of claim 3, wherein the one or more rules comprises:
a content sensitivity associated with the file;
a mismatched file extension associated with the file;
a reputation of a process for accessing the file;
a blacklisted internet protocol address associated with the file;
a file encryption associated with the file;
exfiltration activity associated with the file; or
an endpoint location associated with the file.

6. The method of claim 1, wherein performing, by the computing device, the data loss prevention action on one or more operations associated with the file based on the potential malicious activity comprises blocking the one or more operations associated with the file.

7. The method of claim 1, wherein performing, by the computing device, the data loss prevention action on one or more operations associated with the file based on the potential malicious activity comprises collecting data generated by the one or more operations associated with the file for analysis.

8. The method of claim 1, wherein performing, by the computing device, the data loss prevention action on one or more operations associated with the file based on the potential malicious activity comprises collecting data generated by the one or more operations for updating a data loss prevention model.

9. A system for utilizing lifecycle analytics to enforce data loss prevention policies on potentially malicious content, the system comprising:
a recording module, stored in memory, that records, by a computing device, one or more current activities associated with a file retrieved from a server;
a linking module, stored in memory, that links, by the computing device, the current activities to one or more previously recorded activities associated with the file;
a generation module, stored in memory, that generates, by the computing device, a graph comprising nodes representing an information trail of related events associated with the current activities and the previously recorded activities;
a determination module, stored in memory, that determines, by the computing device, a severity of the information trail based on one or more rules, wherein the severity is associated with a likelihood of potential malicious activity;
a security module, stored in memory, that performs, by the computing device, a data loss prevention action on one or more operations associated with the file based on the potential malicious activity; and
at least one physical processor configured to execute the recording module, the linking module, the generation module, the determination module, and the security module.

10. The system of claim 9, wherein the recording module records, by the computing device, one or more current activities associated with the file retrieved from the server by recording at least one of:
a file creation operation;
a file copy operation;
a file delete operation;
a file read operation;
a file rename operation,
a file write operation;
a file download operation; and
a file upload operation.

11. The system of claim 9, wherein the determination module determines, by the computing device, the severity of the information trail based on one or more rules by:
identifying a file operation associated with each node in the information trail;
applying the one or more rules to the file operation; and
assigning a risk indicator to each node based on the one or more rules.

12. The system of claim 11, wherein the risk indicator corresponds to the likelihood of the potential malicious activity.

13. The system of claim 11, wherein the one or more rules comprises:
a content sensitivity associated with the file;
a mismatched file extension associated with the file;
a reputation of a process accessing the file;
a blacklisted internet protocol address associated with the file;
a file encryption associated with the file;
exfiltration activity associated with the file; or
an endpoint location associated with the file.

14. The system of claim 9, wherein the security module performs, by the computing device, the data loss prevention action on one or more operations associated with the file based on the potential malicious activity by blocking the one or more operations associated with the file.

15. The system of claim 9, wherein the security module performs, by the computing device, the data loss prevention action on one or more operations associated with the file based on the potential malicious activity by collecting data generated by the one or more operations associated with the file for analysis.

16. The system of claim 9, wherein the security module performs, by the computing device, the data loss prevention action on one or more operations associated with the file based on the potential malicious activity by collecting data generated by the one or more operations for updating a data loss prevention model.

17. A non-transitory computer-readable medium comprising one or more computer-readable instructions that, when executed by at least one processor of a computing device, cause the computing device to:
record one or more current activities associated with a file retrieved from a server;
link the current activities to one or more previously recorded activities associated with the file;
generate a graph comprising nodes representing an information trail of related events associated with the current activities and the previously recorded activities;
determine a severity of the information trail based on one or more rules, wherein the severity is associated with a likelihood of potential malicious activity; and
perform a data loss prevention action on one or more operations associated with the file based on the potential malicious activity.

18. The non-transitory computer-readable medium of claim 17, wherein the one or more computer-readable instructions cause the computing device to record one or more current activities associated with the file retrieved from the server by recording at least one of:
a file creation operation;
a file copy operation;
a file delete operation;
a file read operation;
a file rename operation;
a file write operation;
file download operation; and
a file upload operation.

19. The non-transitory computer-readable medium of claim 17, wherein the one or more computer-readable instructions cause the computing device to determine the severity of the information trail based on one or more rules by:
identifying a file operation associated with each node in the information trail;
applying the one or more rules to the file operation; and
assigning a risk indicator to each node based on the one or more rules.

20. The non-transitory computer-readable medium of claim 19, wherein the risk indicator corresponds to a likelihood of the potential malicious activity.
